(19) United States
(12) Patent Application Publication
(10) Pub. No.: US 2009/0249348 A1
(43) Pub. Date: Oct. 1, 2009

(54) METHOD AND APPARATUS FOR OPERATING A THREAD

(76) Inventors: Guojun Xu, Shenzhen (CN); Xiaobo Wang, Shenzhen (CN); Lunjian Mu, Shenzhen (CN); Cheng Huang, Shenzhen (CN); Jue Wang, Shenzhen (CN); Gang Liang, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/484,463

(22) Filed: Jun. 15, 2009

Related U.S. Application Data
(63) Continuation of application No. PCT/CN2008/070189, filed on Jan. 25, 2008.

(30) Foreign Application Priority Data
May 16, 2007 (CN) 200710073814.8

(51) Int. Cl. G06F 9/46

(52) U.S. Cl. 718/102

(57) ABSTRACT

A method and apparatus for operating a thread are disclosed. The method includes: receiving a thread operation request that carries a thread operation ID and thread information related operation; and operating a thread according to the operation request. The thread in the embodiments of the present disclosure is independent of the actual content. Therefore, the thread file can be operated according to the requirements of the user, and thus the user experience is improved.

### CROSS-REFERENCE TO RELATED APPLICATIONS

This application is a continuation of International Patent Application No. PCT/CN2008/070189, filed Jan. 25, 2008, and entitled “METHOD AND APPARATUS FOR OPERATING A THREAD,” which claims the benefit of priority to Chinese Patent Application No. 200710073814.8, filed May 16, 2007, and entitled “METHOD AND APPARATUS FOR OPERATING A THREAD”, both of which are incorporated herein by reference in their entireties.

### FIELD OF THE DISCLOSURE

The present disclosure relates to communication technologies, and in particular, to a method and apparatus for operating a thread.

### BACKGROUND OF THE DISCLOSURE

In a message system in the prior art, users have their own storage areas, such as network storage areas and local storage areas. Users may store some messages, history records of sessions and media in these storage areas. The contents that a user stores may be associated with each other, that is, some contents may be related to a subject. In addition, the user may be interested in this subject within a certain time. Therefore, a thread may be established for contents that are associated with a subject so that the user can operate and use the subject related contents through the thread.

For example, in a mail system in the prior art, the mail system may compare the subjects, senders, recipients and dates of mails by using an algorithm automatically, and organize associated mails into a thread, thus connecting the associated mails in series. As shown in FIG. 1, because subjects of message A, message B, message C, and message D include “product release”, the mail system establishes a thread for these four messages according to the subjects.

The method for establishing a thread in the mail system in the prior art is as follows: one or multiple thread ID fields are added to the headers of mails, so that the threads to which the mails belong can be differentiated by the thread ID fields.

During the process of implementing the present disclosure, it was discovered that the thread in some message systems in the prior art is used for search and specifically for associating contexts. In addition, the thread is implemented by adding one or multiple IDs to the headers of mails or messages. Nevertheless, the mail system prohibits the user from creating, deleting or modifying the thread.

### SUMMARY OF THE DISCLOSURE

Embodiments of the present disclosure provide a method and apparatus for operating a thread so as to operate a thread file according to the requirements of a user and improve the user experience.

To achieve the preceding objective, an embodiment of the present disclosure provides a method for operating a thread. The method includes: receiving a thread operation request, where the request carries a thread operation ID and thread information related to the operation; and operating a thread according to the information carried in the operation request.

Another embodiment of the present disclosure provides a method for operating a thread. The method includes: changing an actual content in a storage; determining that a thread is associated with the actual content, and modifying the thread according to an automatic compliance policy of the content; or determining that no thread is associated with the actual content, and creating a thread according to the automatic compliance policy of the content.

Another embodiment of the present disclosure provides an apparatus for operating a thread. The apparatus includes: a first unit adapted to receive a thread operation request, where the request carries a thread operation ID and thread information related to the operation; and a second unit adapted to perform a related operation according to the thread information carried in the operation request.

Another embodiment of the present disclosure provides an apparatus for operating a thread. The apparatus includes: a first unit adapted to change an actual content in a storage; a second unit adapted to determine that a thread is associated with the actual content and modify the thread according to the index association of the actual content; or a third unit adapted to determine that no thread is associated with the actual content, and create a thread according to an automatic compliance policy of the content.

Compared with the prior art, embodiments of the present disclosure make the thread independent of the actual content. Therefore, the thread file can be operated according to the requirements of the user, and the user experience is improved.

### BRIEF DESCRIPTION OF THE DRAWINGS

FIG. 1 is a schematic diagram of a thread in a mail system in the prior art;

FIG. 2 shows a process of operating a thread file in an embodiment of the present disclosure;

FIG. 3 is a schematic diagram of a thread file in the form of an index association in an embodiment of the present disclosure;

FIG. 4 shows a process of creating a thread file based on a content according to an automatic compliance policy of the content in an embodiment of the present disclosure;

FIG. 5 shows a process of creating a thread based on the content in an embodiment of the present disclosure;

FIG. 6 shows a process of creating a thread file during an ongoing session in an embodiment of the present disclosure;

FIG. 7 shows a process of moving a thread file stored in a network storage by an aggregation agent in an embodiment of the present disclosure;

FIG. 8 shows a process of copying a thread file stored in a network storage in an embodiment of the present disclosure;

FIG. 9 shows a process of searching for a thread file stored in a network storage in an embodiment of the present disclosure; and

FIG. 10 is a schematic diagram of a thread file in the form of an actual content association in an embodiment of the present disclosure.

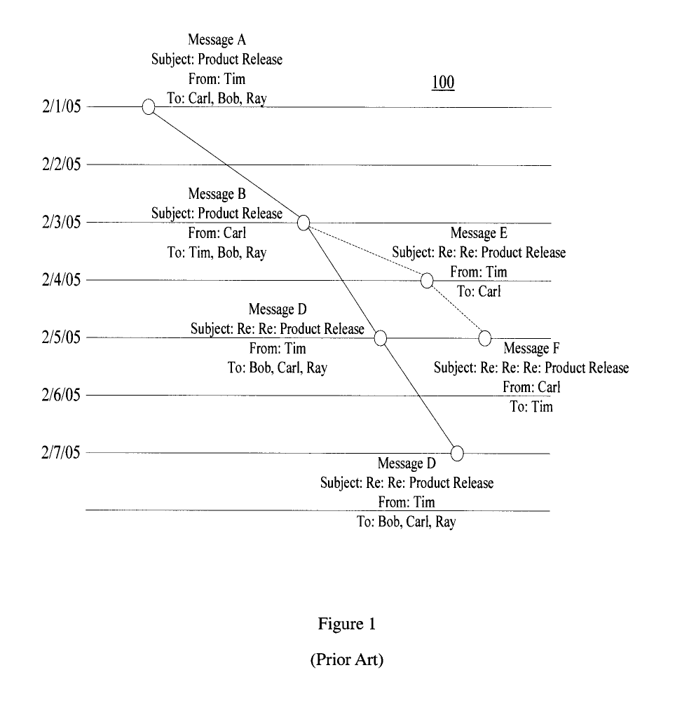

### DETAILED DESCRIPTION OF THE DISCLOSURE

The present disclosure is hereinafter described in detail with reference to the accompanying drawings and preferred embodiments.

The thread used in an embodiment of the present disclosure is not an ID that is added to the header, middle or end of the actual content, but is independent of actual content related to the thread. For example, the thread may be in the form of a file, a database or other forms. The forms of the thread in an embodiment of the present disclosure, for example, a file, a database or other forms, do not affect the thread operation process. The subsequent embodiments describe the thread file operation only, which may be reference for the operations of threads in the form of a database or other forms. Thus, the embodiments of the present disclosure make it convenient for the system to create, move and modify the thread.

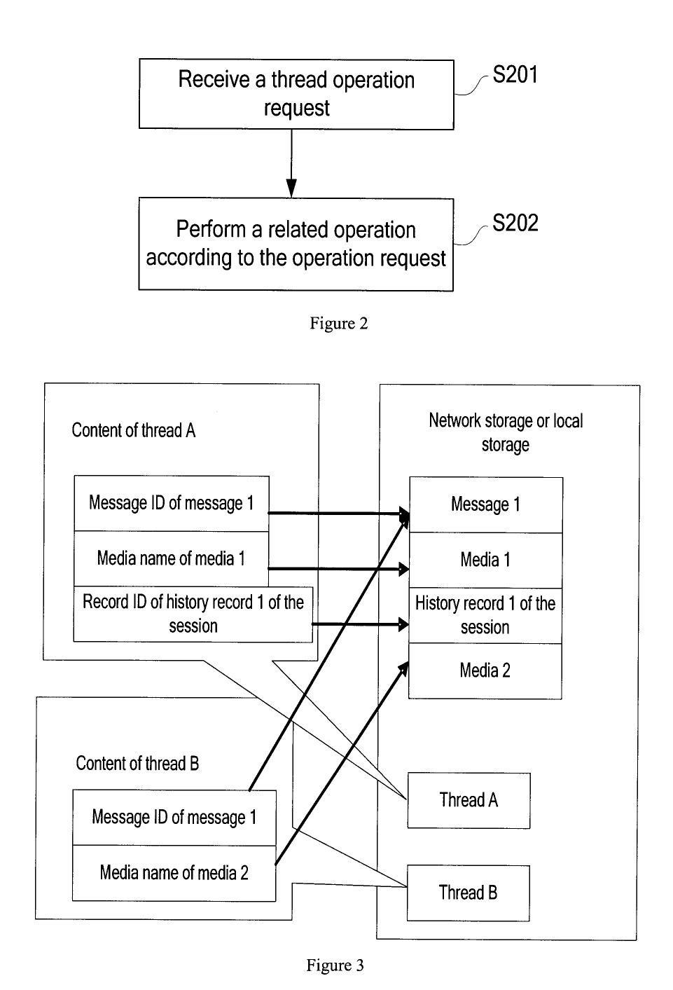

As shown in FIG. 2, a method for operating a thread file in an embodiment of the present disclosure includes the following steps.

S201. A thread operation request is received, where the thread operation request carries an operation ID, thread information related to the operation and an automatic compliance policy of the thread or content. Operations on the thread in an embodiment of the present disclosure include creating the thread, moving, copying, deletion, search, modification (addition or deletion of a thread content) of the thread, and using the thread. The automatic compliance policy of the content includes, but is not limited to, a policy determined according to the frequency of a keyword, a policy of associating a message with a reply to the message, and a policy created by an algorithm automatically. The automatic compliance policy may also be a policy about how the system operates the thread automatically and a policy about how to operate the thread. If the actual content is deleted, the automatic compliance policy of the content may be deleting the related thread content or identifying the related thread content.

S202. A related operation is performed according to the information in the thread operation request, for example, creating, moving, copying, deleting, searching for, modifying (adding or deleting the thread content) the thread, and using the thread file.

The thread in the form of a file in an embodiment of the present disclosure may exist in the form of an index association or an actual content association. Therefore, an embodiment of the present disclosure is described based on two solutions: operations on the thread files in the form of an index association and in the form of an actual content association.

FIG. 3 is a schematic diagram of a thread file in the form of an index association in an embodiment in the first solution of the present disclosure. In this embodiment, the thread may be stored in a network storage or a local storage as a file. This is different from the prior art in which the thread exists in the headers of mails or messages as IDs. The thread content, also the content of the thread file, is an index association of related contents in the local storage or network storage. It includes, but is not limited to, the message ID of a message, media name of a media (the media may be an independent media file or the media in a message and a history record of the session), and record ID of the history record of the session. Only one copy of the associated actual content exists in the storage. As shown in FIG. 3, thread A and thread B have the message ID of message 1, and there is only one index association. Thus, only one copy of message 1 exists in the storage. In this case, creating, copying, deleting or modifying the thread does not affect the actual content. The thread in the form of an index association may be a file in the format of the extensible markup language (XML) that includes the index association of some contents related to a subject. The following gives an example of a simple XML Schema of the thread file:

<?xml version = “1.0” encoding = “UTF-8”?>
<xs:schema targetNamespace = “urn:oma:params:xml:ns:thread” xmlns =

“urn:oma:params:xml:ns:thread” // Root element of the thread

elementFormDefault = “qualified” attributeFormDefault = “unqualified”>
<!-- This import brings in the XML language attribute xml:lang-->
<xs:import namespace = http://www.w3.org/XML/1998/namespace schemaLocation

= “http://www.w3.org/2001/xml.xsd”/>

<!-- The root element: thread -->
<xs:element name = “thread”>

<xs:complexType>

<xs:sequence maxOccurs = “unbounded”>

<xs:element name = “name” type = “string”/>
<xs:choice maxOccurs = “unbounded”>

<xs:element name = “message” type = “messagetype” maxOccurs =

“unbounded”/> // Child element message

<xs:element name = “media” type = “mediatype” maxOccurs =

“unbounded”/> // Child element media

<xs:element name = “convhistory” type = “convhistorytype”

maxOccurs = “unbounded”/> //Child element convhistory

</xs:choice>

</xs:sequence>

</xs:complexType>

</xs:element>
<xs:complexType name = “messagetype”>

<xs:sequence maxOccurs = “unbounded”>

<xs:element name = “messageid” type = “xsrstring” />
<xs:element name = “jointime” type = “xs:dateTime” />
<xs:element name = “directory” type = “xs:anyURI” />

</xs:sequence>

</xs:complexType>
<xs:complexType name = “mediatype”>

<xs:sequence maxOccurs = “unbounded”>

<xs:element name = “medianame” type = “xs:string” />
<xs:element name = “jointime” type = “xs:dateTime” />
<xs:element name = “directory” type = “xs:anyURI” />

</xs:sequence>

</xs:complexType>
<xs:complexType name = “convhistorytype”>

<xs:sequence maxOccurs = “unbounded”>

<xs:element name = “recordid” type = “xs:string” />
<xs:element name = “jointime” type = “xs:dateTime” />
<xs:element name = “directory” type = “xs:anyURI” />

</xs:sequence>

</xs:complexType>

It can be seen from the preceding XML Schema of the thread file that the root element is a thread and may be divided into three sub-elements:

(1) “Message”: adapted to identify the index association of a message in the thread, and including message ID, join time, and directory.

(2) “Media”: adapted to identify the index association of a media in the thread, and including media name, join time, and directory.

(3) “Convhistory”: adapted to identify the index association of a history record of the session in the thread, and including the record ID of the history record, join time, and directory.

The following gives an example of a document of thread A.

<?xml version = “1.0” encoding = “UTF-8”?>
<thread xmlns = “urn:oma:params:xml:ns:thread”> // Root element of
the thread

<name>threadA</name>
<message> //Child element message

<messageid>ID1</messageid>
<jointime>200703111033</jointime>
<directory>//storage/a/messageid1</directory>

</message>
media> //Child element media

<medianame>media1</medianame>
<jointime>200703111100</jointime>
<directory>//storage/b/media1</directory>

</media>
<convhistory> // Child element convhistory

<recordid>convhistory1</recordid>
<jointime>200703111233</jointime>
<directory>//storage/c/convhistory1</directory>

</convhistory>

</thread>

The thread may be stored in the local storage or network storage. The thread-related content may be stored in the local storage or network storage.

The user may use the client to create a thread based on an interesting message, an ongoing session, a stored history record of the session after a session is complete, or a session content or a file content of a media file. In addition, the user may create a thread based on the content that is obtained according to a policy. The user may also create an empty thread. Alternatively, the system may create a thread automatically according to some policies.

To create a thread by using the client, an embodiment of the present disclosure sets a thread name, a subject and an automatic compliance policy of a content according to the wishes of the user, and constructs an XML file that includes the index association of the content. Optionally, the client may decide whether to use the automatic compliance policy of the content to search the whole local storage according to the wishes of the user, and add all the contents complying with the policy to the thread file. The client stores the constructed thread file in a directory that the user specifies in the local storage. In addition, the client may automatically create a thread for the user according to the automatic compliance policy of some contents only. The automatic compliance policy may be preset by the user or defaulted by the system. For example, the client may automatically create a thread according to some algorithms; or like the mail system, the client may create a thread for a message and all reply messages thereof; or the client determines whether to create a thread according to the frequency of a keyword. The automatic compliance policies of all the threads may be stored locally for the use of the client. The client checks contents received in the local storage according to the automatic compliance policies of all the threads when necessary, and adds the contents complying with the policies to a thread.

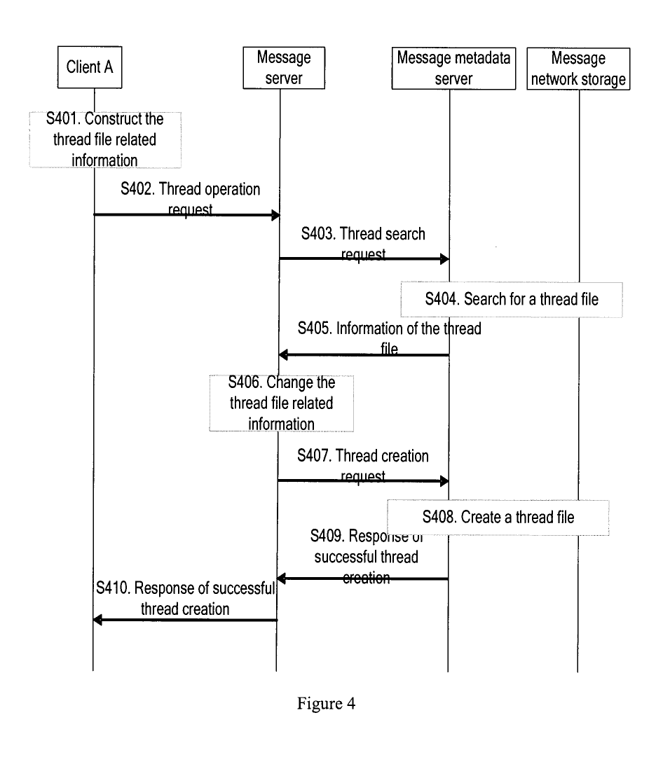

FIG. 4 shows a process of creating a thread based on contents in an embodiment of the present disclosure. The process includes the following steps:

S401. Client A constructs the related information of the thread file, such as the thread name, subject, automatic compliance policy of the content, directory in the network storage for storing the thread file, and the like. The related information of the thread file refers to the thread information.

S402. Client A sends an operation request to a message server. The operation request is a request of creating thread, that is, the request carries the thread operation. The operation request also carries constructed the related information of the thread, including the name, subject or content of the thread, and directory for storing the thread in the network storage. The request of creating thread may use the form of a Session Initial Protocol (SIP) REFER message or other forms. The following gives an example of the SIP REFER message.

REFER sip:CreateThread@hostname SIP/2.0 // Indicating that the server creates a

thread

...
Refer-To: <”threadname”:method = REFER> // Indicating that the server creates a

thread and specifying the name of the new thread (including the directory)

| ... | |
|---|---|
| Content-Type: multipart/mixed;boundary = “boundary1” | |
| Content-Length: ... | |
| --boundary1 | |
| Content-Type: text/plain | |
| ... | // Specific content of the thread, including the subject and |

automatic compliance policy of the content

--boundary1-

S403. The message server sends a thread search request to a message metadata server, and the thread search request carries the automatic compliance policy of the content.

S404. The message metadata server obtains the content from a message network storage according to the automatic compliance policy of the content.

S405. The message metadata server sends the obtained content or association of the content to the message server.

S406. The message server adds the index association of the content complying with the automatic compliance policy that is searched out in the message network storage to the related information of the thread according to the information sent by the message metadata server.

S407. The message server sends a request of creating thread to the message metadata server, for example, an XML document management (XDM) server. The request of creating a thread carries the related information of the thread that is changed by the message server, including the thread name, subject, and index association of the content. The request of creating thread may further carry such information as the storage directory of the thread file and automatic compliance policy of the content.

S408. The message metadata server creates a thread file according to the request of creating thread, and stores the created thread file in the network storage according to the storage directory. The message metadata server may also store the automatic compliance policy of the content. If the thread operation request does not carry the storage directory of the thread file, the message metadata server may store the thread file according to its own setting or system default setting.

S409. The message metadata server returns a response message of successfully creating a thread to the message server.

S410. The message server returns the response message of successfully creating a thread to client A.

In this embodiment, the message server, message metadata server, and message network storage are called a message system, which may exist as a whole or independently.

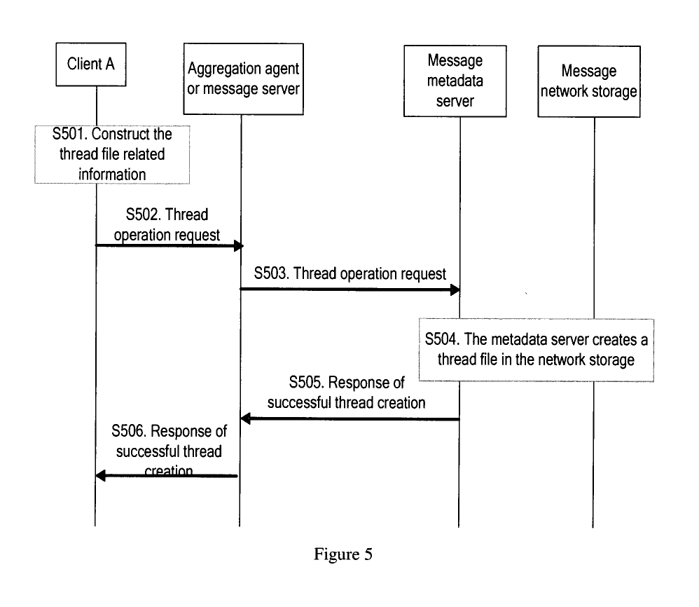

In addition to the preceding method for creating a thread file based on contents according to the automatic compliance policy of the content, an embodiment of the present disclosure provides another method for creating a thread file based on contents without the automatic compliance policy of the content. As shown in FIG. 5, this method includes the following steps:

S501. Client A constructs the related information of the thread file. That is, the user uses the client to construct the related information of the thread file according to a message of interest, a stored history record of the session after a session is complete or a media as the content; or the user constructs the related information of the thread file based on some contents that are searched out according to a policy; or the user may create an empty thread. The user needs to set the thread name, subject, automatic compliance policy of the content, storage directory in the network storage, and index association of the content. The content related information may be an XML file.

S502. Client A sends a thread operation request to the aggregation agent or message server. The thread operation request may be a request of creating a thread, that is, the thread operation request carries the ID for creating a thread. The thread operation request may also include the related information of the thread file that is constructed by client A, such as the thread name, subject, automatic compliance policy of the content, storage directory in the network storage, and index association of the content. The thread operation request may or may not carry the storage directory in the network storage and index association of the content.

S503. The aggregation agent or message server sends the thread operation request to the message metadata server, for example, an XDM server. The thread operation request may be in the form of an XML Configuration Access Protocol (XCAP) PUT request or other form.

S504. The message metadata server creates a thread file in a specified directory in the network storage according to the thread file related information in the thread operation request. The message metadata server may also store the automatic compliance strategy of the content in the metadata server. If the thread operation request does not carry the storage directory of the thread file, the message metadata server may store the thread file according to its own setting or system default setting.

S505. The message metadata server returns a response message of successfully creating a thread to the aggregation agent or message server.

S506. The aggregation agent or message server returns the response message of successfully creating a thread to client A.

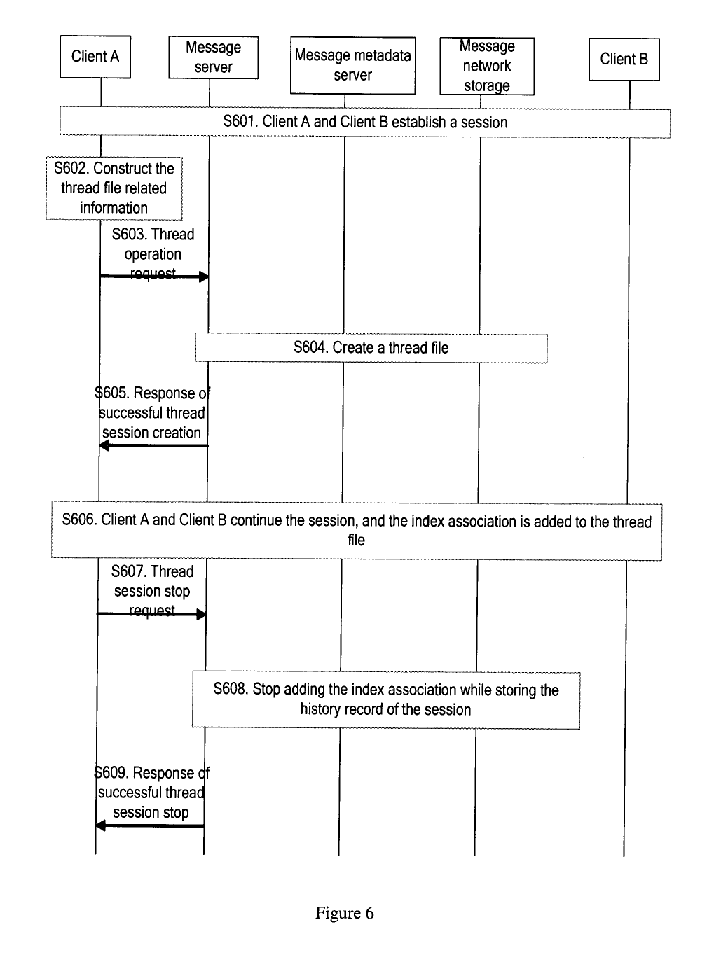

In addition, the user may create a thread file during the ongoing session, as shown in FIG. 6. This process includes the following steps:

S601. Client A and client B establish a session and the session is ongoing.

S602. Client A constructs the related information of the thread file. According to the wishes of the user, Client A sets the thread name, subject, session ID, session name or automatic compliance policy of the content, and directory of the thread file in the network storage. In this embodiment, the automatic compliance policy of the content involves tracing and recording of contents of an ongoing session. Other automatic compliance policies may also be involved.

S603. Client A sends a thread operation request to the message server. The thread operation request may be a thread session creation request. That is, the thread operation request carries the ID for creating a thread session. The thread operation request includes the related information of the thread file that is constructed by client A, such as the thread name, subject, automatic compliance policy of the content, and storage directory in the network storage.

The thread operation request message may use the form of a SIP REFER message or other forms to create a thread. If the SIP REFER message is used, the following gives an example of the request.

REFER sip: CreateThreadSession@hostname; SIP/2.0 // Indicating that the server

creates a thread

| ... | |
|---|---|
| Refer-To: <“new_threadname”: method = REFER> | // Indicating that the |

server creates a thread and specifying the name of the new thread (including the directory)

Target-Dialog: 592435881734450904;local-tag = 9m2n3wq;remote-tag = 763231

// Specifying the related session

...
Content-Type: multipart/mixed; boundary = “boundary1”
Content-Length: ...
--boundary1
Content-Type: text/plain
// Specific content of the thread, including the subject and automatic compliance

policy of the content

--boundary1-

S604. The message metadata server creates a thread file in the network storage according to the related information of the thread file in the thread operation request message. The message server traces the session, and adds the index association to the thread file when the message metadata server stores the actual content of the session. The message server also updates the modified thread file through the message metadata server. The index association is the index association of the actual content of the session that is stored during the ongoing session. The message metadata server may also store the automatic compliance policy of the content.

S605. The message server returns a response message of successful session creation to client A.

S606. Client A and client B continue the session. The message metadata server adds the related index association to the thread file while storing the history content of the session.

S607. Client A sends a thread session stop request to the message server.

The thread session stop request may be in the form of a SIP REFER message or other forms.

The following gives an example of the SIP REFER message.

REFER sip: StopThreadSession@hostname SIP/2.0 // Indicating that the server

stops the thread session

| ... | |
|---|---|
| Refer-To: <“threadname”: method = REFER> | // Indicating that the server |

stops the thread session and specifying the name of the thread (including the directory)

Target-Dialog: 592435881734450904;local-tag = 9m2n3wq;remote-tag = 763231

// Specifying the session

...

S608. The message server stops adding the index association to the thread file while storing the history record of the session according to the requirements in the thread session stop request.

Or the message server automatically stops recording the history content of the session in the thread file when the session is complete.

S609. The message server returns a response message of successful thread session stop to client A.

Optionally, an existing thread may be specified to record the content of the session.

Like the client, the message metadata server in the message system may also create a thread for the user according to the automatic compliance policies of some contents. These policies may be preset by the user or defaulted by the system.

The automatic compliance policies of all the threads in the message system may be stored in the metadata server for the use of the system. The system checks received contents according to the automatic compliance policies of all the threads when necessary, and adds the index association of the contents that comply with the policies to a thread.

The automatic compliance policies of all the threads stored in the client or message system may be added, modified or deleted by the user. The processing of automatic compliance policies on the client is simple. The user may modify these policies directly. The automatic compliance policies stored in the message system need to be processed through the XCAP protocol or other modes.

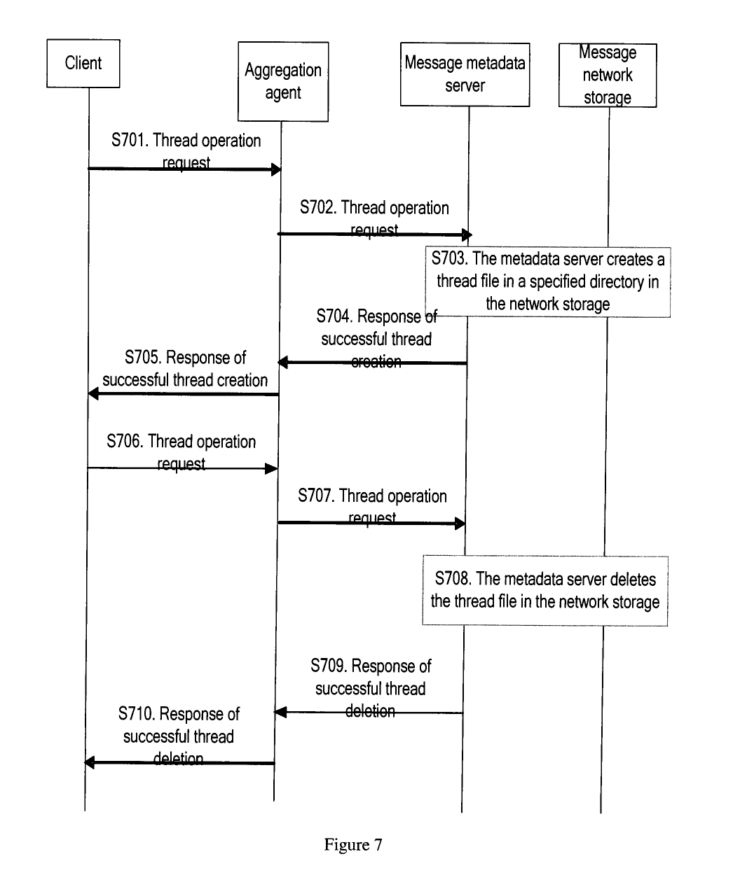

FIG. 4, FIG. 5 and FIG. 6 provide methods for creating a thread file in embodiments of the present disclosure. In addition, some embodiments of the present disclosure provide a method for moving a thread file. Moving a thread file may be performed in the local storage and the network storage. Moving a thread in the local storage does not affect the actual contents because the thread file is an XML file that indicates the index association of some actual contents. Further, the thread is stored as an independent file in a directory in the local storage, so it can be moved between directories like other files. Moving a thread file in the network storage may be performed through the aggregation agent or message server. FIG. 7 shows a process of moving a thread file in the network storage through the aggregation agent. The process includes the following steps:

S701 to S702. The client sends a thread operation request to the message metadata server through the aggregation agent. The thread operation request carries an ID for creating a thread file, for example, XCAP PUT or other forms, the thread file to be created or thread file related information, and directory for storing the moved thread file.

Before sending the thread operation request, the client may obtain the thread file to be moved or the related information of the thread file. In this step, the thread file to be moved or the related information of the thread file is the ID for creating the thread file and the thread file to be created or the related information of the thread file carried in the thread operation request.

S703. The message metadata server creates a new thread file in the network storage according to the directories for storing the thread file and moved thread file in the request of creating thread.

S704 to S705. The message metadata server returns a response message of successfully creating thread to client A through the aggregation agent or message server, and notifies client A of creating the thread successfully.

S706 to S707. Client A sends a thread operation request to the message metadata server through the aggregation agent or message server. The thread operation request includes the thread file to be deleted or the related information of the thread file and an ID for deleting the thread, for example, XCAP DELETE.

S708. The message metadata server deletes the thread file in the network storage according to the information in the thread operation request.

S709 to S710. The message metadata server returns a response message of successful thread deletion to the client through the aggregation agent or message server, and notifies the client of deleting the old thread successfully.

When moving a thread file, client A may also send a thread move request to the message metadata server through the message server. The message metadata server directly moves the thread file to a directory specified in the request according to the thread move request, without creating a thread file first, that is, without copying the original thread file. This simplifies the process. In this embodiment, the thread move request may be a SIP REFER message, which is described as follows:

REFER sip:MoveThread@hostname;movefolder = “movetofolder” SIP/2.0 //

Indicating that the server moves the thread to a new directory

| ... | |
|---|---|
| Refer-To: <“threadname”:method = REFER> | // Indicating that the server |

moves a thread and specifying the name of the thread to be moved (including the
directory)

...

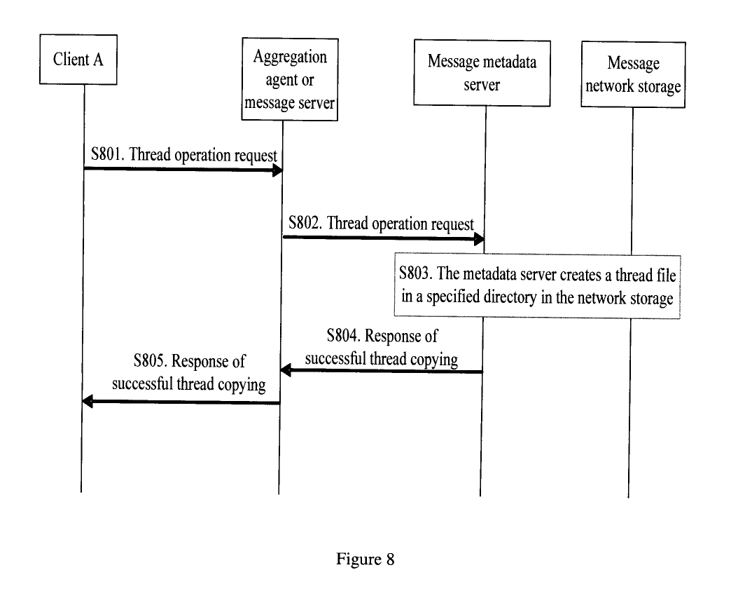

In addition, some embodiments of the present disclosure provide a method for copying a thread file. Like moving a thread file, copying a thread file may be performed in the local storage and the network storage. Copying a thread in the local storage does not affect the actual contents because the thread file is an XML file indicating the index association of some actual contents. Further, the thread is stored as an independent file in a directory in the local storage, so it can be copied between directories like other files. If a thread file is copied in a same directory, the name and subject of the thread file after copying need to be changed. Copying a thread file in the network storage may be performed through the aggregation agent or message server. FIG. 8 shows a method for copying a thread file in the network storage. The method includes steps similar to S701 to S705. That is, the client sends a thread operation request to the message metadata server through the aggregation agent or message server, where the request carries a copy ID, related information of the thread file to be copied, and directory for storing the thread file after copying. The message metadata server sends a success response to client A after the thread file is copied according to the request.

In addition, some embodiments of the present disclosure provide a method for deleting a thread file. Like copying and moving a thread file, deleting a thread file may be performed in the local storage and the network storage. Similar to the method for copying a thread file shown in FIG. 8, the method for deleting a thread file in the network storage includes: The client sends a thread operation request to the message metadata server through the aggregation agent or message server, where the thread operation request carries related information of the thread file to be deleted and an ID for deleting the thread file. The message metadata server returns a success response to client A after the thread file is deleted according to the request.

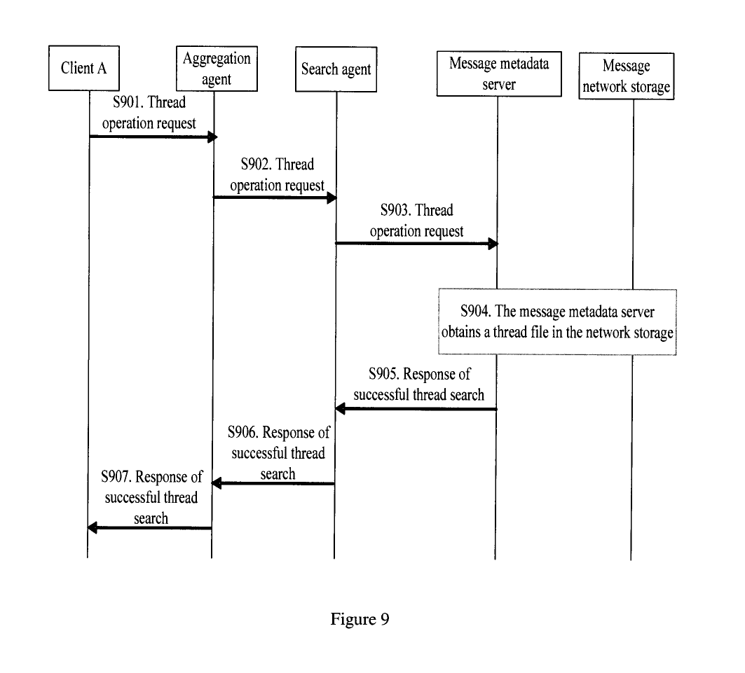

In addition, some embodiments of the present disclosure provide a method for searching for a thread file. Unlike copying, moving and deleting a thread file, searching for a thread file can be performed only by the aggregation agent. Further, a search agent in the message system is used for receiving a thread search request. The method for searching for a thread file in the local storage is the same as that in the prior art. As shown in FIG. 9, the method for searching for a thread file in the network storage includes the following steps:

S901. Client A sends a thread operation request to the aggregation agent, where the thread operation request carries an ID for searching for a thread and specified search conditions, such as a thread file name, a character string, and a subject. The search request may be in the form of a Hypertext Transfer Protocol (HTTP) POST request or other form.

S902 to S903. The aggregation agent sends the thread operation request to the message metadata server through the search agent.

S904: The message metadata server searches the network storage according to the search conditions in the preceding request, and obtains the thread file meeting the search conditions.

S905 to S907. The message metadata server returns a response of successful thread search to the client through the search agent and aggregation agent, notifies the client of searching successfully, and returns the thread file.

In general, searching for a thread file may be the basis for other operations on a thread file. For example, moving, modifying or deleting a thread file may be performed after the client obtains the thread file through searching. The client may also operate a thread file without obtaining the thread file. The client may carry the related information of the thread file in the request, and instruct the message metadata server to obtain the thread file according to the related information of the thread file in the request. Then, the client moves, copies, modifies or deletes the thread file.

In addition, some embodiments of the present disclosure provide a method for modifying a thread file. In general, modifying a thread file includes adding, modifying or deleting the thread file related information and the content of the thread file (also the association). The method for modifying a thread file in the local storage is similar to that in the prior art. The method for modifying a thread file in the network storage in an embodiment of the present disclosure is similar to the method for copying a thread file shown in FIG. 8. That is, the client sends a thread operation request to the message metadata server through the aggregation agent or message server, where the request includes an ID for modifying a thread, related information of the thread file to be modified, and information of the modified thread file, such as an instruction for adding, deleting or modifying a certain association. The message metadata server returns a success response to client A after the thread file is modified according to the request.

In addition, some embodiments of the present disclosure provide a method for using a thread file. To use a thread file is to obtain the actual content that is associated with the thread file through the thread file. The actual content of the thread file is obtained by selecting the association in the thread file. Different from copying, modifying or deleting a thread file, using a thread file has no difference in the local storage or network storage. During the operations on a thread file, the actual content associated by the association in the thread file may be deleted or moved. Embodiments of the present disclosure provide the following two ways to avoid the deletion of the actual content: First, the actual content is reversely associated with the thread. Therefore, the index association in the thread is deleted when the actual content is deleted. Second, the actual content is not associated with the thread. Therefore, after the actual content is deleted, the user is prompted that the actual content is deleted when using the thread and the association that associates the deleted actual content is marked in the thread file. The marked association may be deleted by the user or the user may know that the content is deleted without retrieving the content when using the thread next time. The preceding two ways may also be used in the case that the actual content is moved.

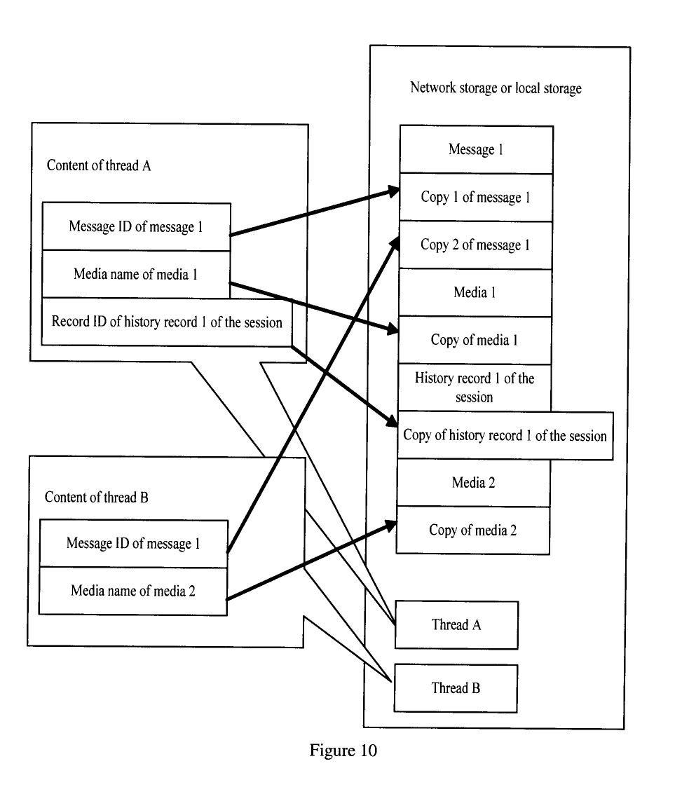

FIG. 10 shows a thread file in the form of an actual content association in an embodiment in the second solution of the present disclosure. Unlike the embodiment in FIG. 2, the thread in this embodiment is associated with the copy of the actual content, and the copied actual content is used for this thread only. If another thread uses the same content, another copy of the actual content needs to be made. Therefore, multiple copies of the actual content related to the thread exist in the storage. For message 1 in FIG. 10, thread A and thread B have the actual content of message 1. The system may provide two copies of the content of message 1 for thread A and thread B. Therefore, three copies of the content of message 1 exist in the storage. Because the copied content must be stored with the actual content in a same directory, the thread file using the actual content association may also be in the XML format.

In the second solution, moving, searching for and using the thread file are similar to the operations on the thread file using the index association. Creating a thread file is the same as that in the first solution except that an individual copy of the actual content in the storage is required. When a thread file is deleted, the copy of the actual content that is associated with the thread file also needs to be deleted. When a thread file is copied, the actual content of the thread file also needs be copied.

In addition, in some embodiments of the present disclosure, the aggregation agent or the message server may receive and forward operation requests sent from the client. In general, an operation request may be in the form of XCAP, SIP REFEE, HTTP or other forms.

If a thread file is stored in the local storage, the client may modify, delete or copy the thread file using the index association. For a thread file using the actual content association, the operation on the thread file may be changed according to the methods provided in the preceding embodiments because the actual content may be stored in the local storage or network storage. This may be implemented by those skilled in the art who understand the methods provided in the embodiments of the present disclosure.

In addition, some embodiments of the present disclosure provide a method for operating a thread. As mentioned earlier, the system may store the automatic compliance policy of the content in an operation request after receiving the thread operation request. Meanwhile, the user may set the automatic compliance policy of the content directly in the message system or through the client. Therefore, the client is not required to send a thread operation request to operate a thread file. That is, when the system changes the actual content in the storage, the system operates a thread file according to the automatic compliance policy of the content in the storage. If no thread file related to the new actual content exists and the automatic compliance policy of the content indicates that a thread file needs to be created according to the policy, a new thread file is created according to the index association of the actual content. If a thread file related to the new actual content already exists, the thread file is searched out, and the index association of the actual content is added to the thread file. The process of changing the actual content in the storage by the system includes: receiving a new actual content, that is, adding a new actual content, such as new messages or stored contents of a new session that the client participates in; and modifying, deleting or moving the actual content in the storage. It can be predicted that a new thread file may be stored in the local storage or network storage. In general, the automatic compliance policy of the content may provide a directory for storing the new thread file. Further, the thread file where an index association is added may be stored in any position. If the preceding thread file is associated with the actual content, a copy of the received actual content needs to be made when the index association is added.

Similarly, deleting or modifying a thread file (mainly an index association) may be performed according to the stored automatic compliance policy of the content without receiving the thread file operation request. For example, the automatic compliance policy of the content may be set as follows: when the actual content related to the thread file is changed, the thread file is changed if such change affects the thread file. If the changed actual content is irrelevant to the thread file, the record that is associated with the changed actual content in the thread file is deleted. If the directory of the actual content is changed, the index association that associates the actual content in the thread file may be modified. If the actual content is deleted, the related part of the thread file may be deleted.

A time may be set in the system for operating a thread file through time triggering. That is, when a preset time condition is met, the system checks and obtains the change details of the actual content and changed actual content in the storage; for example, the actual content is received, modified, moved or deleted. Then, the system may operate (for example, delete and modify) the related thread file according to the change details and the automatic compliance policy of the content.

An apparatus for operating a thread in an embodiment of the present disclosure includes a first unit, a second unit, and a third unit.

The first unit is adapted to receive a thread operation request, where the request carries a thread operation ID, thread related information or a thread file. The thread operation ID is the ID for creating a thread, and the thread related information includes the name and subject of the thread file, and automatic compliance policy of the content. The request further carries a directory for storing the thread. The second unit is adapted to operate the thread in the storage according to the operation request received by the first unit. The second unit includes a third unit, a fourth unit, and a fifth unit.

The third unit is adapted to create a thread file in the directory for storing the thread according to the related information or automatic compliance policy of the content. The fourth unit is adapted to obtain the actual content that is associated with the preceding related information. The fifth unit is adapted to add the index association of the actual content to a thread.

An apparatus for operating a thread in an embodiment of the present disclosure includes a first unit, a second unit, a third unit, and/or a fourth unit.

The first unit is adapted to change the actual content in the storage. The second unit is adapted to determine that a thread file is associated with the actual content according to the pre-stored automatic compliance policy of the content, and modify the stored thread file according to the index association of the actual content. The third unit is adapted to determine that no thread file is associated with the actual content according to the stored automatic compliance policy of the content, and create a thread file according to the automatic compliance policy of the content. The fourth unit is adapted to obtain the changed actual content in the storage according to the preset time.

According to the preceding descriptions, those skilled in the art may understand that embodiments of the present disclosure can be implemented by software plus a necessary hardware platform or by hardware only. Based on this understanding, the technical solution of the present disclosure may be represented by a computer software product. The computer software product is stored in a storage medium, and includes multiple commands that enable a computer device (a personal computer, a server or a network device) to perform the methods provided in the embodiments of the present disclosure.

Although the present disclosure has been described through several exemplary embodiments, the disclosure is not limited to such embodiments. It is apparent that those skilled in the art can make various modifications and variations to the disclosure without departing from the spirit and scope of the disclosure. The present disclosure is intended to cover such modifications and variations provided that they fall in the scope of protection defined by the following claims or their equivalents.

What is claimed is:

1. A method for operating a thread, comprising:
receiving a thread operation request, wherein the thread operation request carries a thread operation ID and thread information related to a thread operation; and
operating a thread according to the information carried in the operation request.

2. The method of claim 1, wherein the thread operation ID includes instructions to create the thread, and the operating the thread according to the information in the operation request comprises:
creating the thread according to the thread information.

3. The method of claim 2, wherein the thread information comprises at least one of thread name, subject, and automatic compliance policy of a content; and the method further comprises:
adding an index association of an actual content that is associated with the at least one of the thread name, the subject, and the automatic compliance policy of the content to the thread.

4. The method of claim 2, wherein the thread information comprises at least one of thread name, subject, and a session ID, and the method further comprises:
adding an index association of an actual content of a session that is associated with at least the one of the thread name, the subject, and the session ID to the thread.

5. The method of claim 2, wherein the thread operation request further carries a directory for storing the thread, and the process of creating the thread comprises:
creating the thread in the directory for storing the thread.

6. The method of claim 4, further comprising:
receiving a thread session stop request; and
stopping the adding the index association of the actual content of the session according to the thread session stop request.

7. The method of claim 1, wherein the thread operation ID comprises at lease one of an: ID for creating the thread, an ID for moving the thread, an ID for copying the thread, an ID for deleting the thread, an ID for searching for the thread, an ID for modifying the thread, and an ID for using the thread.

8. The method of claim 7, wherein the content of the thread is an association of an actual content and the thread operation ID instructs to create a thread, copy a thread, or modify a thread; and the method further comprises:
copying the actual content that is associated with the thread.

9. The method of claim 7, wherein the content of the thread is the association of the actual content, and the thread operation ID indicates to delete a thread; and the method further comprises:
deleting an actual content used by the thread.

10. A method for operating a thread, comprising:
changing an actual content in a storage;
determining whether a thread is associated with the actual content;
operating the thread according to the determination result.

11. The method of claim 10, wherein the determination result is that a thread is associated with the actual content, and operating the thread according to the determination result comprises:
modifying the thread according to an automatic compliance policy of the content.

12. The method of claim 10, wherein the determination result is that no thread is associated with the actual content, and operating the thread according to the determination result comprises:
creating a thread according to the automatic compliance policy of the content.

13. The method of claim 10, wherein the content of the thread is an index association or an actual content association; and
the thread is independent of the actual content of the thread.

14. The method of claim 11, wherein
the changing the actual content in the storage comprises:
adding the actual content to the storage; and
the modifying the thread according to the automatic compliance policy of the content comprises:
adding an index association of the actual content to the thread according to the automatic compliance policy of the content.

15. The method of claim 12, wherein
the changing the actual content in the storage comprises:
deleting the actual content in the storage; and
the modifying the thread according to the automatic compliance policy of the content comprises:
deleting the index association that associates the actual content in the thread according to the automatic compliance policy of the content, or adding the ID deleted from the actual content to the index association that associates the actual content.

16. The method of claim 12, wherein
the changing the actual content in the storage comprises:
modifying the actual content in the storage; and
the modifying the thread according to the automatic compliance policy of the content comprises:
deleting the index association that associates the actual content in the thread file before the modification if determining that the actual content after the modification is irrelevant to the thread file.

17. The method of claim 12, wherein
the changing the actual content in the storage comprises:
moving the actual content in the storage; and
the modifying the thread according to the automatic compliance policy of the content comprises:
changing the index association that associates the actual content in the thread file according to the automatic compliance policy of the content.

18. An apparatus for operating a thread, comprising:
a first unit adapted to receive a thread operation request, wherein the thread operation request carries a thread operation ID and thread information related to the operation; and
a second unit adapted to perform a related operation according to the thread information carried in the operation request.

19. The apparatus of claim 18, wherein the thread operation ID is an ID for creating a thread, and the thread information is at least one of a thread name, a subject, and an automatic compliance policy of a content; and the second unit comprises:
a third unit adapted to create the thread in a directory for storing the thread according to the related information or automatic compliance policy of the content;
a fourth unit adapted to obtain an actual content that is associated with the related information; and
a fifth unit adapted to add an index association of the actual content to the thread.

20. An apparatus for operating a thread, comprising:
a first unit adapted to change an actual content in a storage;
a second unit adapted to determine that a thread is associated with the actual content and modify the thread according to an index association of the actual content; or
a third unit adapted to determine that no thread is associated with the actual content, and create a thread according to an automatic compliance policy of the content.
